(19) United States
(12) Patent Application Publication
(10) Pub. No.: US 2012/0200686 A1
(43) Pub. Date: Aug. 9, 2012

(54) INTRAORAL CAMERA WITH LIQUID LENS

(76) Inventors: Zaiguang Yu, Pudong District (CN); Zhaohua Liu, Yangpu (CN); Tan Wang, Pudong (CN); Mantao Xu, Baoshan District (CN); jiwu Zhang, Pudong (CN)

(21) Appl. No.: 13/499,935

(22) PCT Filed: Oct. 30, 2009
(86) PCT No.: PCT/CN2009/001208

§ 371 Date: Apr. 3, 2012

(51) Int. Cl. H04N 7/18

(52) U.S. Cl. 348/66; 348/E07.085

(57) ABSTRACT

An auto focus intraoral camera with liquid lens includes: a digital imaging sensor (304) for capturing a digital image of an object; a light source for illuminating the object; an imaging lens assembly (302) for directing the light from the object along an optical path toward the digital imaging sensor; a liquid lens (100) disposed in the optical path between the imaging lens assembly and the digital imaging sensor, where the liquid lens has an adjustable focal length; a driver (306) for applying a variable voltage to the liquid lens to control the focal length of the liquid lens; and a processor (308) for processing the digital image captured by the digital imaging sensor. Meanwhile, a continuously auto focusing method for an intraoral camera is disclosed.

### FIELD OF THE INVENTION

The invention relates generally to an intraoral imaging camera system. More specifically, the invention relates to an intraoral camera with liquid lens for continuous and single auto focus.

### BACKGROUND OF THE INVENTION

A dental professional, such as a dentist, may desire to capture an image of a patient's teeth prior to providing dental care. Images of the teeth of the patient can be taken and stored as data before treatment, and a plan for the treatment can be made on the basis of the captured images. In addition, during the course of treatment, images of the interior of an oral cavity may be taken and stored as data for enabling both the dentist and the patient to review the progress of the treatment and for use as presentation materials in academic conferences. An intraoral camera can be employed to capture images. Images of the oral cavity can be displayed for purposes of diagnosis, treatment, patient education and the like.

Generally, an intraoral camera comprises an illumination module, lens module and electrical parts. Some intraoral cameras may employ means to capture the image digitally, for example, using a digital sensor.

In some intraoral cameras, focus adjustment is performed by manually adjusting the distance between the lens and sensor. However, this method is not convenient for dentists to operate. Some of the intraoral camera will use small NA (numerical aperture) that can provide big DOF (depth of field) to replace focus adjustment. But small NA optical system cannot provide high resolution and increase the luminous flux.

Accordingly, there is a need to provide an intraoral camera having continuous and single auto focus.

### SUMMARY OF THE INVENTION

An object of the present invention is to provide an intraoral camera with continuous and single auto focus.

The intraoral camera comprises: (1) a digital imaging sensor for capturing a digital image of an object; (2) a light source for illuminating the object; (3) an imaging lens assembly directing the light from the object along an optical path toward the digital imaging sensor; (4) a liquid lens disposed in the optical path between the imaging lens assembly and the digital imaging sensor, the liquid lens having an adjustable focal length; (5) a driver applying a variable voltage to the liquid lens to control the focal length of the liquid lens; and (6) a processor for processing the digital image captured by the digital imaging sensor.

In another arrangement, there is provided an intraoral camera comprising: (1) a digital imaging sensor for capturing a digital image of an object; (2) a light source for illuminating the object; (3) an first imaging lens assembly directing the light from the object along an optical path toward an intermediate plane to form an intermediate image; (4) a second imaging lens assembly including a liquid lens, the second imaging lens assembly being disposed in the optical path between the first imaging lens assembly and the digital imaging sensor, the liquid lens having an adjustable focal length relaying the intermediate image to the digital imaging sensor; (5) a driver applying a variable voltage to the liquid lens to control the focal length of the liquid lens; and (6) a processor for processing the digital image captured by the digital imaging sensor.

This object is given only by way of illustrative example, and such object may be exemplary of one or more embodiments of the invention. Other desirable objectives and advantages inherently achieved by the disclosed invention may occur or become apparent to those skilled in the art. The invention is defined by the appended claims.

The compact intra oral camera according to the present application provides a small size and simple structure with liquid lens for auto focus.

### BRIEF DESCRIPTION OF THE DRAWINGS

The foregoing and other objects, features, and advantages of the invention will be apparent to those skilled in the art from the following more particular description of the embodiments of the invention, as illustrated in the accompanying drawings. The elements of the drawings are not necessarily to scale relative to each other.

FIG. 1 shows a system structure of an intraoral camera with liquid lens.

FIG. 2 shows an example of an intraoral camera with liquid lens.

FIGS. 3A and 3B show structure of a liquid lens.

FIG. 4 shows the working principle of a liquid lens.

FIG. 5 shows the design flowchart of the intraoral camera according to FIG. 3.

FIG. 6 diagrammatically shows electrical structure of an intraoral camera of the present invention.

FIG. 7 shows firmware workflow in the DSP (image processor) of FIG. 6 for continuous auto focus.

FIG. 8 shows the focus areas for the continuous auto focus feature of the intraoral camera.

FIG. 9 shows a flow diagram illustrating the continuous auto focus method.

FIG. 10 shows a flow diagram illustrating the focusing scan process.

FIG. 11 shows the focusing area of a single auto focus.

FIG. 12 shows an exemplary focus value calculation.

FIG. 13 shows a flow diagram illustrating the single auto focus method.

FIG. 14 shows a peak check for the single auto focus method of FIG. 15.

FIG. 15 shows a near or far end focusing check for the single auto focus method of FIG. 13.

FIG. 16 shows a near or far end focusing check for the single auto focus method of FIG. 15.

### DETAILED DESCRIPTION OF THE INVENTION

The following is a detailed description of the preferred embodiments of the invention, reference being made to the drawings in which the same reference numerals identify the same elements of structure in each of the several figures.

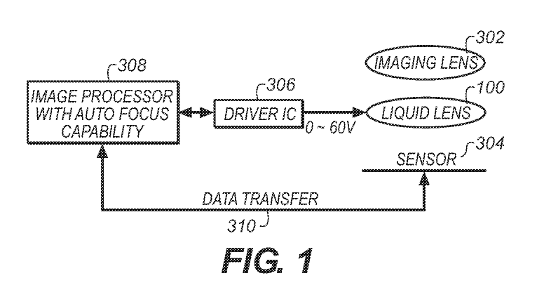

FIG. 1 shows an exemplary intraoral camera system having a liquid lens 100. As shown, the camera includes an imaging lens assembly 302, liquid lens 100, a digital imaging element/sensor 304, a liquid lens driver 306, and an image processor 308, and communication means 310 between sensor 304 and image processor 602. In this arrangement, the focal length of the liquid lens can be adjusted by changing the voltage applied to it. As such, the intraoral camera can focus on the object at different working distances.

Driver 306 provides variable voltage for liquid lens 100. Sensor 304 is used for capturing the images, and image processor 308 is adapted for processing the images captured by the imaging element/sensor 304. The liquid lens 100 is used for auto focusing. In other embodiments, lens assembly 302 can include a liquid lens.

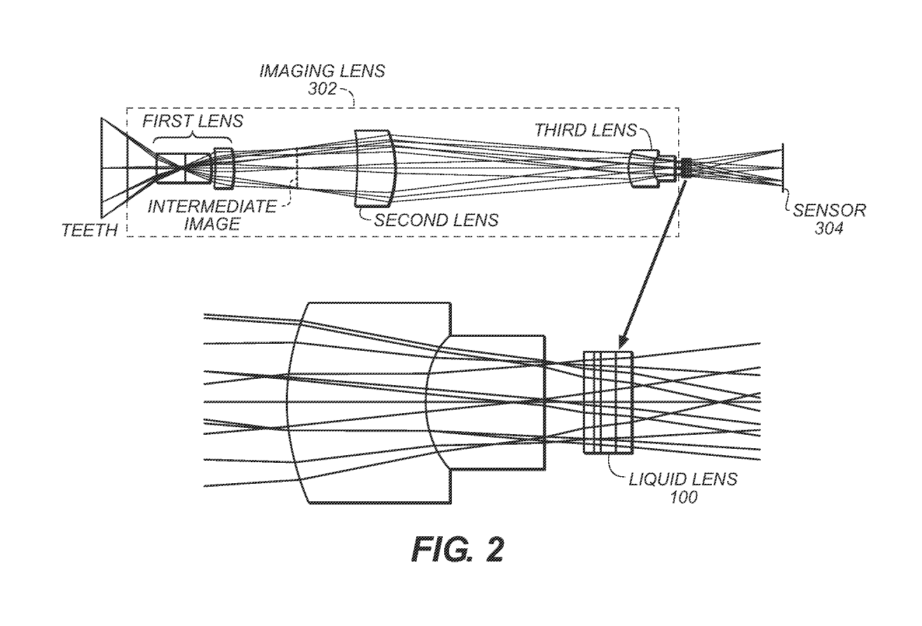

FIG. 2 illustrates an embodiment of an intraoral camera with liquid lens. To provide a large field of view and auto focus, the optical design employs the arrangement shown in FIG. 2. As illustrated, the optical system is comprised of imaging lens assembly 302 and liquid lens 100. Liquid lens driver 306 applies a variable voltage to the liquid lens 100. The imaging element/senor 304 captures the images. The image processor 308 processes the images captured by the sensor 304. The liquid lens 100 is used for focusing and the lens assembly 600 is employed for imaging.

Image lens assembly 302 and liquid lens 100 are disposed intermediate an object to the imaged (e.g., a tooth) and sensor 304. Imaging lens assembly 302 is comprised of three lens groups: a first lens, a second lens, and a third lens. The first lens compresses the large FOV (field of view) to a small FOV and makes an intermediate image of the object. The second and third lenses make the final image on sensor 304 with liquid lens 100 involved. In other words, the sequence is the object, imaging lens assembly 302, liquid lens 100, and sensor 304. These parts are arranged in this manner so that liquid lens 100 can be adjusted for different working distances to help imaging lens assembly 302 form an images on sensor 304.

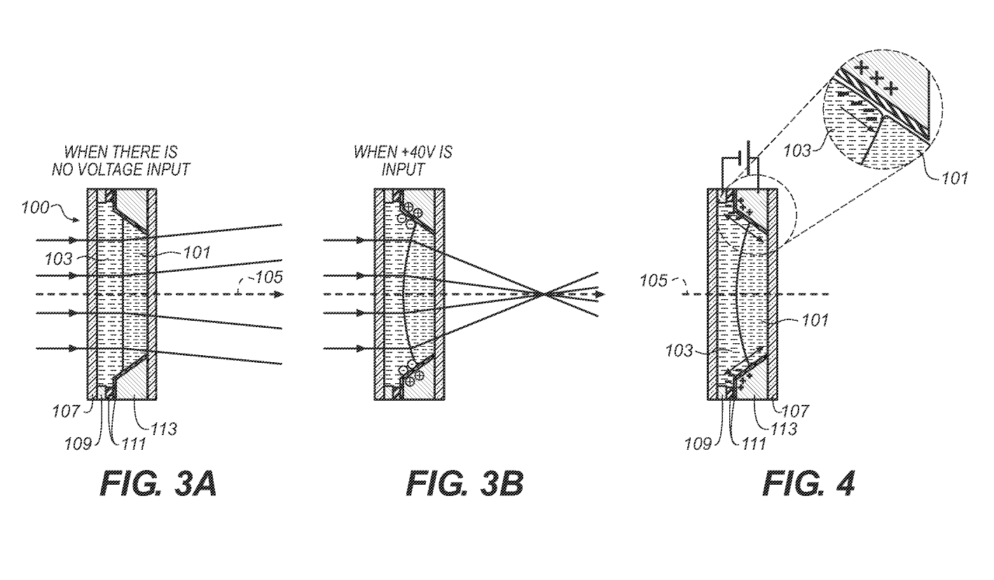

Referring to FIGS. 3A and 3B, the liquid lens 100 generally includes two kinds of liquids of equal density, which are sandwiched between two transparent windows 107 in a conical vessel. In this embodiment, one liquid is water 103, which is conductive, while the other, oil 101, acts as a lid, allowing the engineers to work with a fixed volume of water, and provides a measure of stability for the optical axis 105. Lens 100 further includes electrodes 109 and 113 insulated from oil 101 but in electrical contact with the water 103; and variable voltage can be selectively applied to the electrodes. Insulator 111 is deposited between electrodes 109 and 113 to separate them. The interface between oil 101 and water 103 will change its shape depending on the voltage applied across the conical structure. As shown in FIG. 1A, when zero volts are applied, the surface is flat. When the voltage is increased to 40 volts, the surface of oil 101 becomes highly convex, as figure FIG. 1B shows. In this way, the liquid lens can attain the desired refraction power by means of changing the voltage applied on the electrodes.

FIG. 4 shows the working principle of the liquid lens 100 according to FIG. 1. The liquid lens 100 works based on the electro-wetting phenomenon described below: a water drop 103 is deposited on a substrate made of metal, covered by a thin insulating layer. The voltage applied to the substrate generating an electrostatic pressure to force the liquid change its shape so as to modify the contact angle of the liquid drop. Two iso-density liquids are employed by the liquid lens: one is insulator 101 while the other is conductor 103. The variation of voltage leads to a change of curvature of the liquid-liquid interface, which in turn leads to a change of the focal length of the lens.

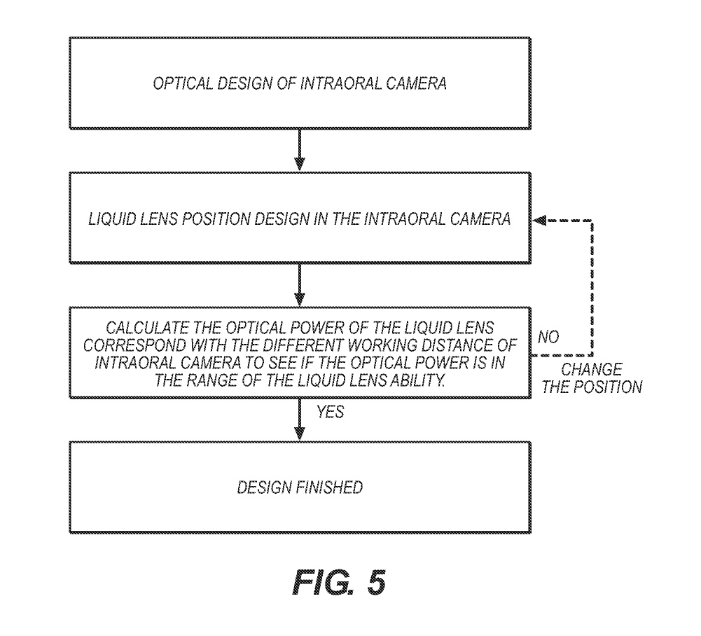

FIG. 5 provides the flowchart of the optical design of intraoral camera. The position of the liquid lens is determined in the intraoral camera; then the optical power of the liquid lens is calculated correspond with the different working distance of intraoral camera to determine whether the optical power is in the range of the liquid lens ability. If the optical power out of the range, then the position of the liquid lens should be relocated and then recalculate the optical power for the determination. If the optical power does succeed the range, which means the position is proper, then the present design goes to end.

As indicated above, a dental professional, such as a dentist, may desire to capture an image or collection of images of a patient's tooth/teeth prior to providing dental care. Or it may be desired to capture a continuous series of images. To provide ease of operation, the intraoral camera provides continuous and single auto focus.

As such, there is provided an intraoral camera comprising: (1) a digital imaging sensor for capturing a digital image of an object; (2) a light source for illuminating the object; (3) an imaging lens assembly directing the light from the object along an optical path toward the digital imaging sensor; (4) a liquid lens disposed in the optical path between the imaging lens assembly and the digital imaging sensor, the liquid lens having an adjustable focal length; (5) a driver applying a variable voltage to the liquid lens to control the focal length of the liquid lens; and (6) a processor for processing the digital image captured by the digital imaging sensor.

As described, there is provided an intraoral camera comprising: (1) a digital imaging sensor for capturing a digital image of an object; (2) a light source for illuminating the object; (3) an first imaging lens assembly directing the light from the object along an optical path toward an intermediate plane to form an intermediate image; (4) a second imaging lens assembly including a liquid lens, the second imaging lens assembly being disposed in the optical path between the first imaging lens assembly and the digital imaging sensor, the liquid lens having an adjustable focal length relaying the intermediate image to the digital imaging sensor; (5) a driver applying a variable voltage to the liquid lens to control the focal length of the liquid lens; and (6) a processor for processing the digital image captured by the digital imaging sensor.

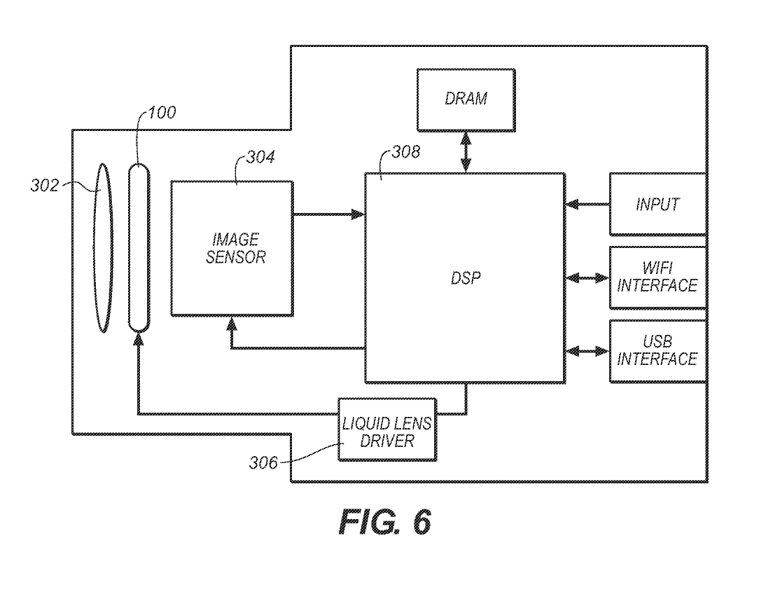

FIG. 6 diagrammatically shows electrical structure of an intraoral camera of the present invention for continuous and single auto focus of the intraoral camera. The system structure includes lens assembly 302, sensor 304, image processor (shown as DSP) 308, liquid lens driver 306, an activation device (such as a button input), and transmission/communication means (for example, USB and Wifi). The optical system is comprised of one or more optical lens and liquid lens. The focal length of the liquid lens can be controlled by the voltage signal loaded on liquid lens.

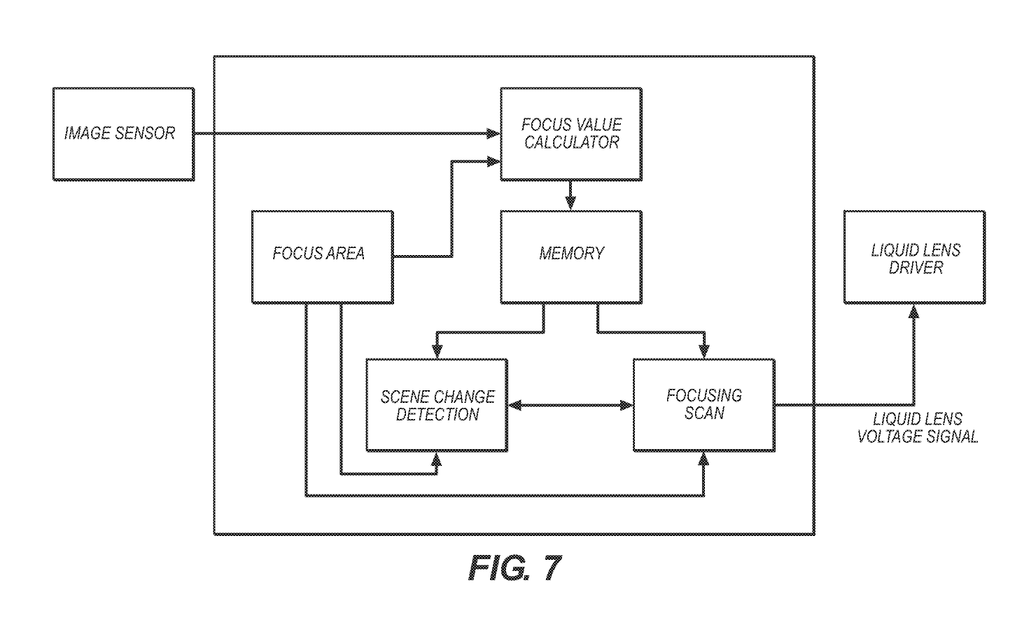

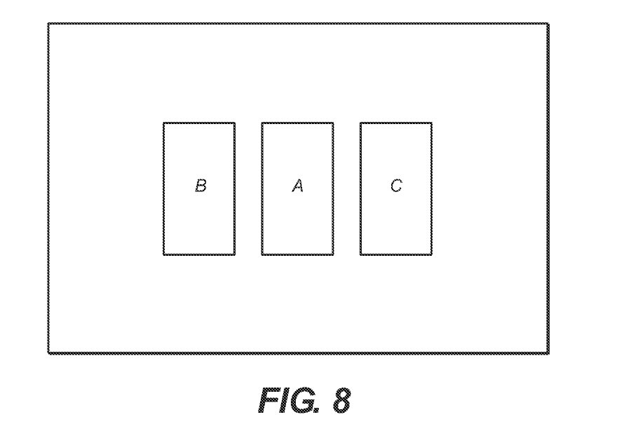

With regard to the DSP (image processor) 308, the function structure is illustrated in FIGS. 7 and 8. FIG. 7 shows firmware workflow in the DSP (image processor) of FIG. 6 for continuous auto focus. For continuous auto focus, three focus areas are segmented in the whole image (illustrated in FIG. 8 as elements A, B, and C). A focus value is determined for every focus area acquired from the image sensor to evaluate the degree of focusing. A series of focus values (recorded at each frame) is obtained along with a corresponding voltage. These values are stored in a focus value array PA[n], and a corresponding voltage array Vol[n]. The either or both arrays can be stored for example, in DRAM or other memory. The scene change detection or focus searching is processed according to the focus status. Scene change detection is executed in every focus area while the focus searching is executed at the focus area where the scene change is detected.

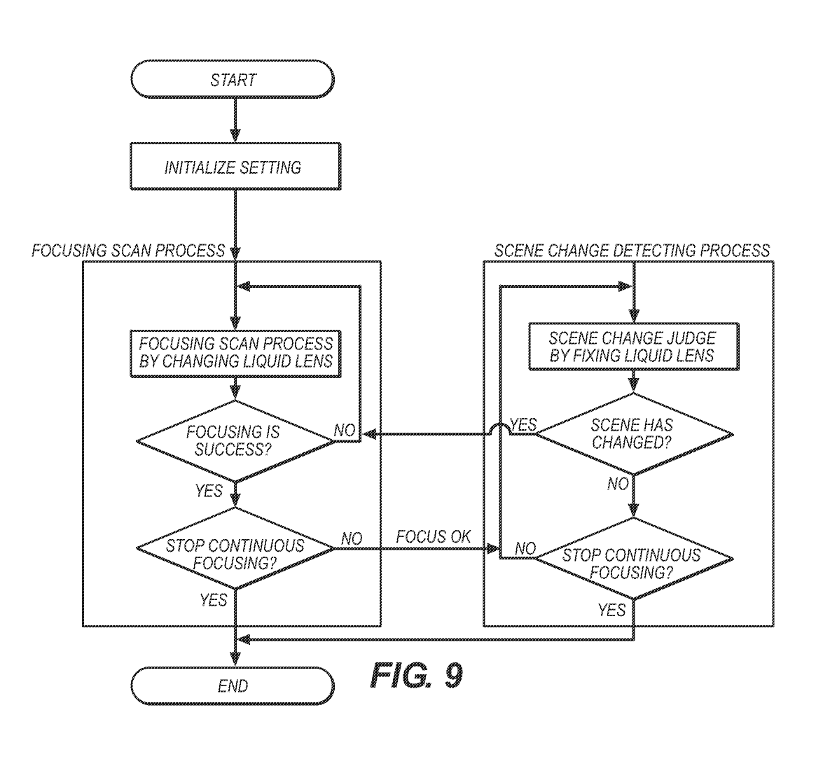

FIG. 9 shows a flow diagram illustrating the continuous auto focus method.

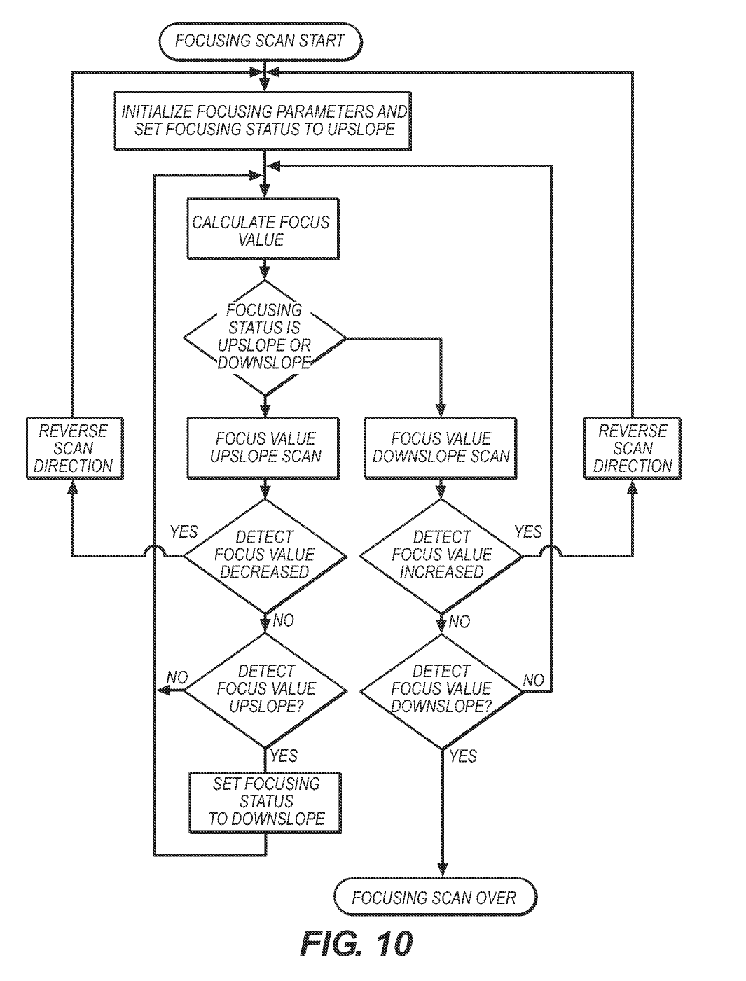

Once power is to the intraoral camera is activated, the continuous auto focus can be activated through an activation device, such as a start/capture button. Several parameters/settings are initialized, such as the focus value calculator and memory. A focus scan is initiated wherein the liquid lens voltage is iteratively changed until the focus position is detected. (This will be described in more detail below with regard to FIG. 10.) Once the focus position is acquired, the scene change process is initiated. If a change in the scene is detected, the iterative focus scan is initiated. If no change in the scene is detected, the iterative focus scan is not initiated. If desired, the intraoral camera can be configured to monitor for a change in the scene at predetermined time intervals. The auto focus can be deactivated through a deactivation device, such as a stop button.

FIG. 10 shows a flow diagram illustrating the focusing scan process shown in FIG. 9 wherein the liquid lens voltage is iteratively changed until the focus position is detected.

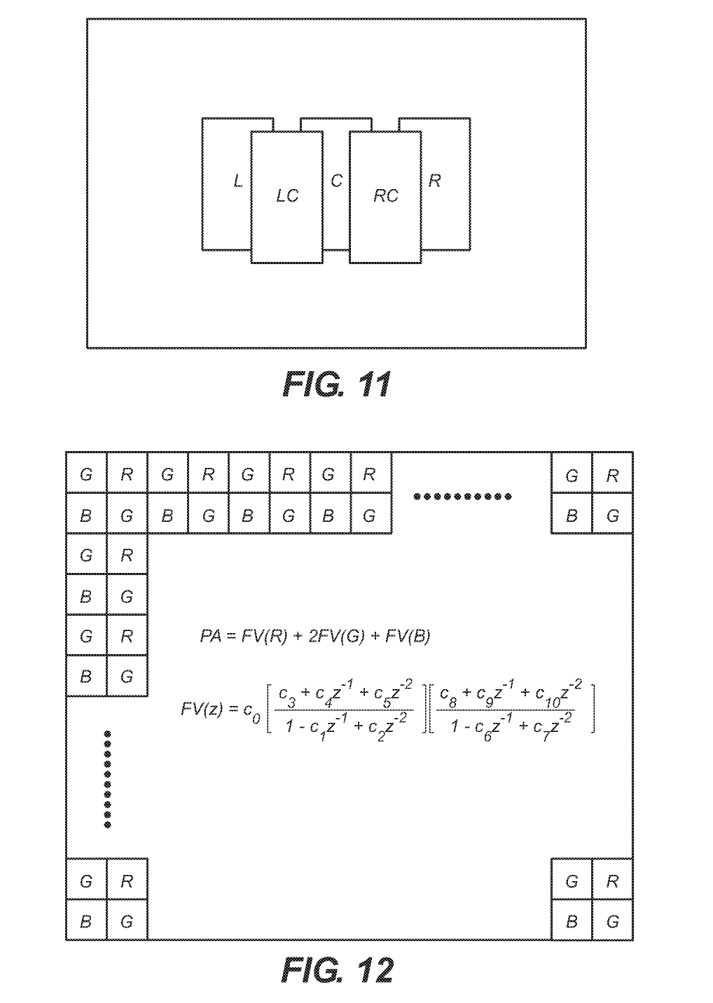

Reference is now made to FIGS. 11 and 12 to describe a single auto focus. FIG. 11 shows the focusing area of a single auto focus. While various numbers of segments can be employed, FIG. 11 shows five focus areas (i.e., C, LC, RC, L, R) that are segmented from the whole image. A focus value is calculated, for example, based on Bayer raw data. This calculation can be made using methods known to those skilled in the art, for example, by processed using 4^{th} order IIR filter as shown in FIG. 12.

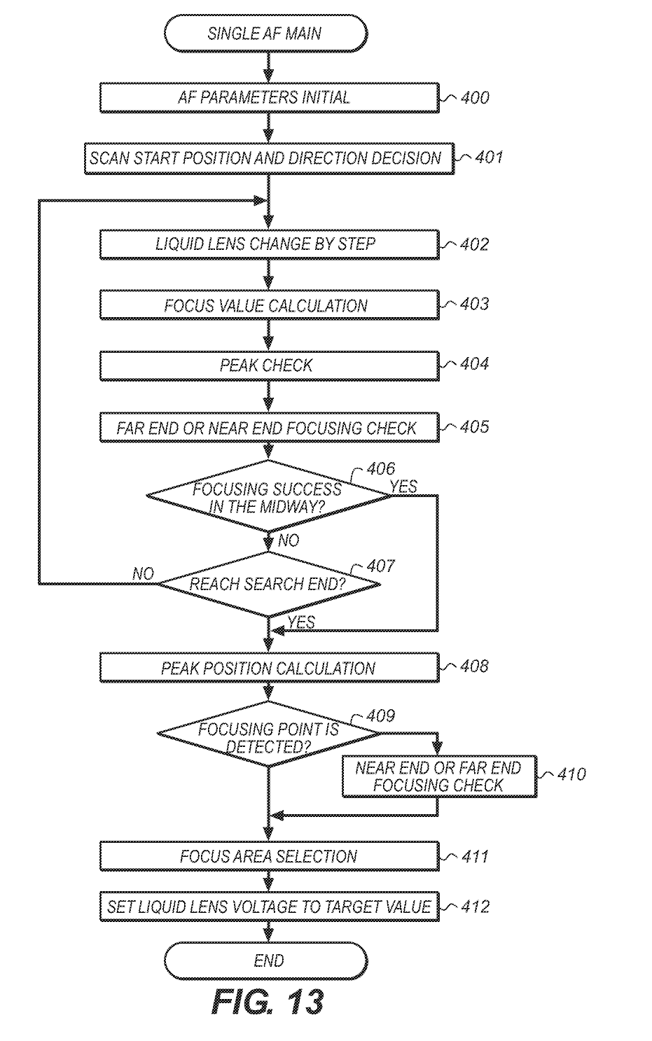

FIG. 13 shows a flow diagram illustrating the single auto focus method. The single auto focus method is now described with reference to FIGS. 13-17.

Once power is to the intraoral camera is activated, the single auto focus can be activated through an activation device, such as a start/capture button.

At Step 400, several parameters/settings are initialized, such as the focus value calculator and memory.

At Step 410, a focus start position and direction is determined. If the current position is closest with the near end, then the focus search will start at the near end. Otherwise it will start at the far end.

Near end is the nearest position from the image lens assembly while far end is the farthest position the lens assembly can image. For the liquid lens voltage, near end corresponds to the biggest voltage VOLN, while far end corresponds to the smallest voltage VOLF

At Step 402, the voltage of liquid lens is increased or decreased at a step/time synchronizing with the video frame.

At Step 403, a focus value is calculated from the video image by high pass filter and is averaged with previous focus value to produce PA[i], wherein i is an array order. This new focus value PA[i] is added to the focus value array. The maximum and minimum value are updated among focus value array by comparing previous maximum and minimum values.

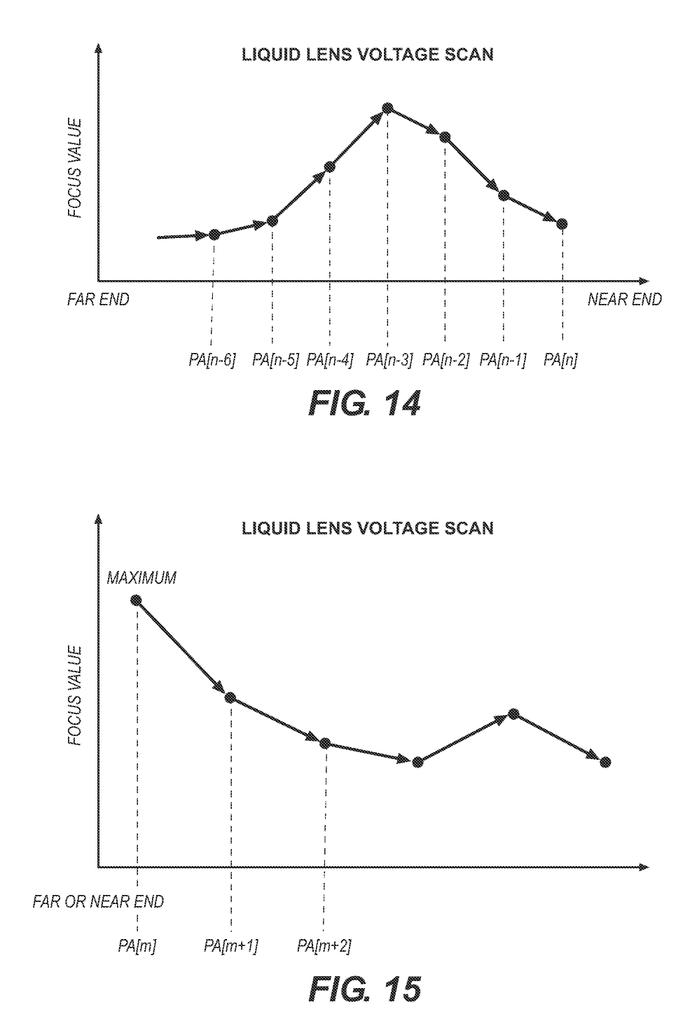

At Step 404, a peak is detected from the focus value array of the five continuous positions, as illustrated in FIG. 14. For example, if the following conditions are met: PA[n−5]<PA[n−4] and PA[n−4]<PA[n−3] and PA[n−3]>PA[n−2] and PA[n−2]>PA[n−1], then PA[n−3] is determined as a peak.

If the following conditions are met: PA[n−5]<PA[n−4] and PA[n−5]<PA[n−4] and PA[n−4]<PA[n−3] and PA[n−3]>PA[n−2] and PA[n−2]>PA[n−1] and PA[n−1]>PA[n], then PA[n−3] is determined as a perfect peak

A flag of midway stop is set. A flag of midway stop refers to the status in which the just focus position is detected and to stop focus scanning

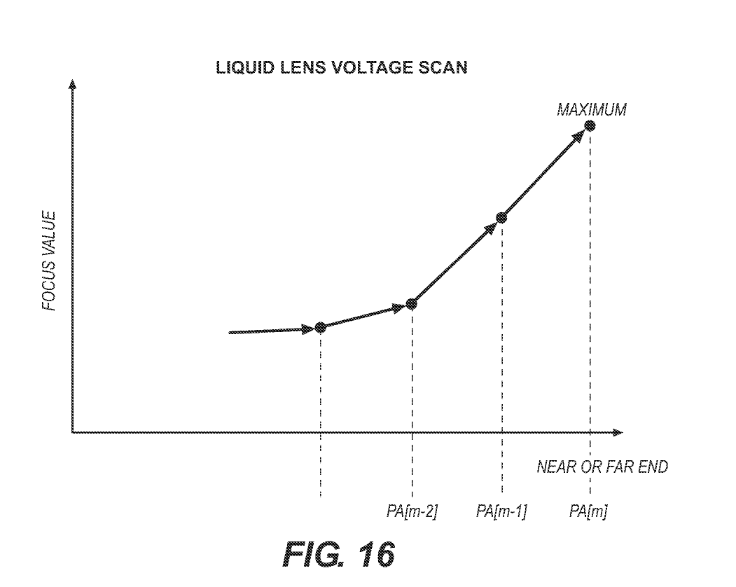

At Step 405, the method determines whether the just focus position is located close to the near end or far end, as illustrated in FIGS. 15 and 16. The near end or far end check are executed at tenth position if the maximum focus value locates in start point. The selection of the tenth position is to assure the reliability of the maximum focus value. If the maximum focus value is PA[m] and Vol[m] is close to near end VOLN or far end VOLF, and meanwhile PA[m]>PA[m+1] and PA[m+1]>PA[m+2], then the just focus position is considered as the start point, that is Vol[m]. The flag of midway stop is set.

At Step 406, the flag of midway stop is checked to determine is there is focusing success. If the flag of midway stop is set, then repetition of Steps 402 to 405 will stop, and the method moves to Step 408.

If the flag of midway stop is not set, then the method moves to Step 407. At Step 407, the method determines whether the focus scanning is completed. If not completed, then Steps 402 to 406 are repeated. If the liquid lens voltage reaches the near end or far end, the repetition of Steps 402 to 406 will be stop, and the method moves to Step 408.

At Step 408, the focus approximate position is calculated using the focus value of five points adjacent to the peak based on the following equation:

y=ax²+ba+c(a<0)

At Step 409, the method determines whether a peak is detected in all five focus areas

If a peak is not detected in all five focus areas, then in Step 410, near or far end checks will be executed at the endpoint.

The method will determine whether the focus value change corresponds with the rule showed in FIG. 16. If the maximum focus value is located close to end for focus value array PA[m] and Vol[m] is close to near end VOLN or far end VOLF, and meanwhile PA[m−2]<PA[m−11] and PA[m−11]<PA[m], then the just focus position is considered as the end point. That is, Vol[m], the just focus position, is considered as the endpoint.

At Step 411, focus areas are selected according to the focus approximate position, with the closest to the near end focus area being selected as the focus area.

At Step 412, the liquid lens is set to the target voltage of the selected focus area.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. An intraoral camera comprising:
a digital imaging sensor for capturing a digital image of an object;
a light source for illuminating the object;
an imaging lens assembly directing the light from the object along an optical path toward the digital imaging sensor;
a liquid lens disposed in the optical path between the imaging lens assembly and the digital imaging sensor, the liquid lens having an adjustable focal length;
a driver applying a variable voltage to the liquid lens to control the focal length of the liquid lens; and
a processor for processing the digital image captured by the digital imaging sensor.

2. An intraoral camera comprising:
a digital imaging sensor for capturing a digital image of an object;
a light source for illuminating the object;
an first imaging lens assembly directing the light from the object along an optical path toward an intermediate plane to form an intermediate image;
a second imaging lens assembly including a liquid lens, the second imaging lens assembly being disposed in the optical path between the first imaging lens assembly and the digital imaging sensor, the liquid lens having an adjustable focal length relaying the intermediate image to the digital imaging sensor;
a driver applying a variable voltage to the liquid lens to control the focal length of the liquid lens; and
a processor for processing the digital image captured by the digital imaging sensor.

3. A method for continuous auto focus for an intraoral camera, comprising:
activating the intraoral camera;
initializing parameters for a continuous auto focus acquisition of an object using the intraoral camera;
applying a predetermined voltage to a liquid lens disposed in an optical path between an imaging lens assembly and a digital imaging sensor, the liquid lens having an adjustable focal length;
iteratively changing a voltage applied to the liquid lens until a focus position is detected; and
acquiring the focus position.

4. The method according to claim 3, further comprising, after acquiring the focus position, monitoring for a scene change.

5. The method according to claim 4, further comprising, when a scene change is detected, initiating a scene change process.
